(19) United States
(12) Patent Application Publication
(10) Pub. No.: US 2022/0081972 A1
(43) Pub. Date: Mar. 17, 2022

(54) Ladder Stabilization Assembly

(71) Applicant: Eugene Haines, Simpsonville, SC (US)

(72) Inventor: Eugene Haines, Simpsonville, SC (US)

(21) Appl. No.: 17/022,571

(22) Filed: Sep. 16, 2020

(51) Int. Cl. E06C 7/42; E06C 7/50

(52) U.S. Cl. CPC E06C 7/423; E06C 7/50

(57) ABSTRACT

A ladder stabilization assembly for inhibiting a ladder from tipping laterally includes a pair of eyebolts that can each be attached to a respective leg of a ladder. A tube is insertable through each of the eyebolts such that the tube is oriented to extend along a horizontal axis. In this way the tube is aligned with a support surface on which the ladder is standing to inhibit the ladder from tipping laterally.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to stabilization devices and more particularly pertains to a new stabilization device for inhibiting a ladder from tipping laterally.

### (2) Description of Related Art Including Information Disclosed Under 37 CFR 1.97 and 1.98

The prior art relates to stabilization devices including a pair of brackets that is each coupled to a respective leg of a ladder and to inhibit the ladder from tipping laterally. The prior art discloses a variety of ladder stabilizers that include a pair of arms that angle away from respective legs of a ladder for stabilizing the ladder. Additionally, the prior art discloses a ladder stabilizer that comprises a panel and a pair of sockets on the panel that each receive a leg of a ladder for stabilizing the ladder. The prior art discloses a variety of ladder stabilizers that includes telescopic legs that are extendable laterally away from a ladder for stabilizing the ladder.

### BRIEF SUMMARY OF THE INVENTION

An embodiment of the disclosure meets the needs presented above by generally comprising a pair of eyebolts that can each be attached to a respective leg of a ladder. A tube is insertable through each of the eyebolts such that the tube is oriented to extend along a horizontal axis. In this way the tube is aligned with a support surface on which the ladder is standing to inhibit the ladder from tipping laterally.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a ladder stabilization assembly according to an embodiment of the disclosure.

FIG. 2 is an exploded perspective view of an eyebolt and a tube of an embodiment of the disclosure.

FIG. 3 is a perspective view of an embodiment of the disclosure.

FIG. 4 is a cut-away in-use view of an embodiment of the disclosure.

FIG. 5 is a perspective view of a clip of an embodiment of the disclosure.

### DETAILED DESCRIPTION OF THE INVENTION

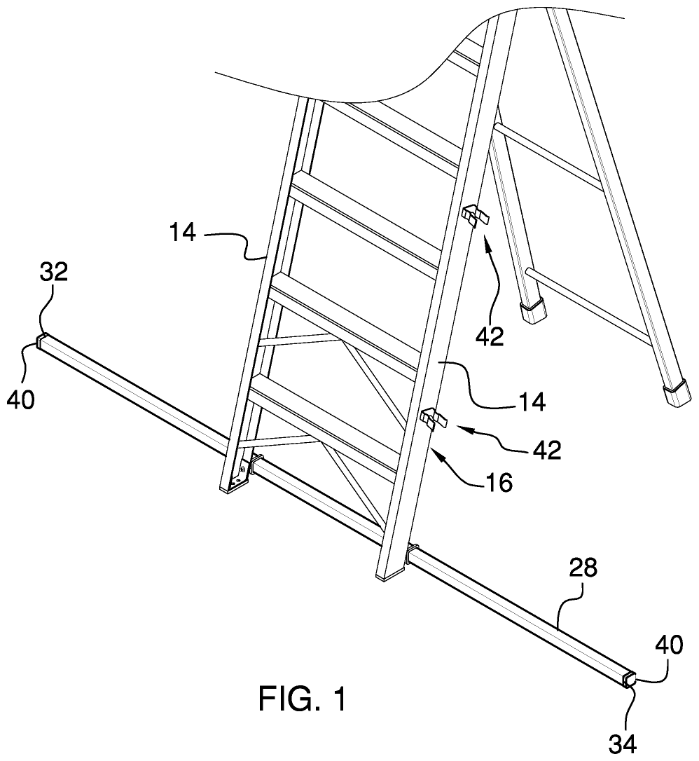

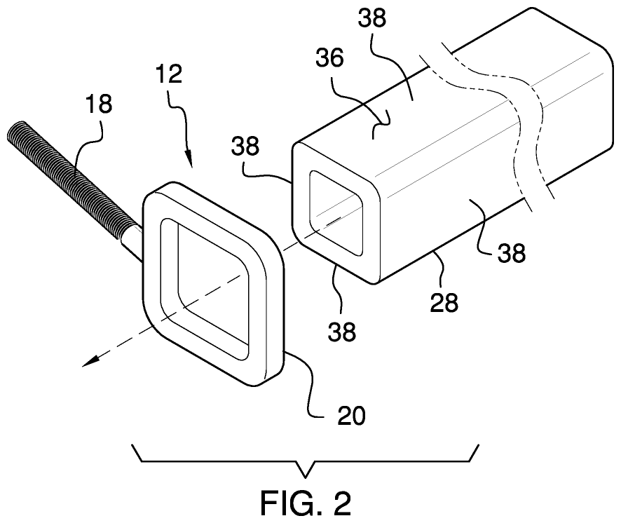

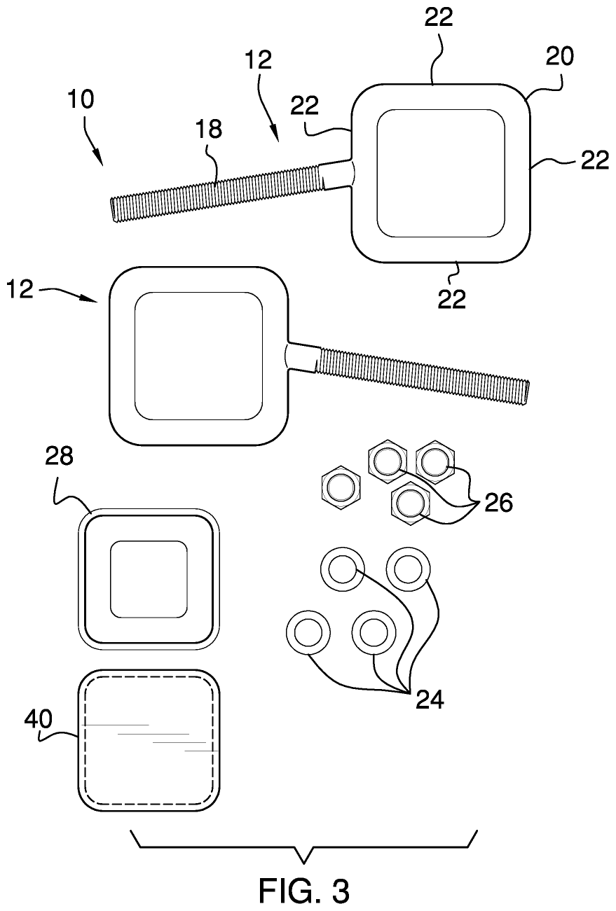

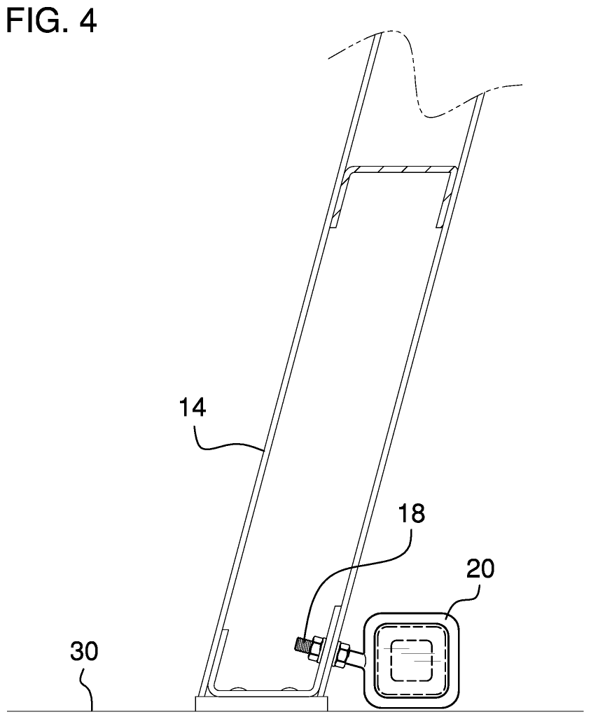

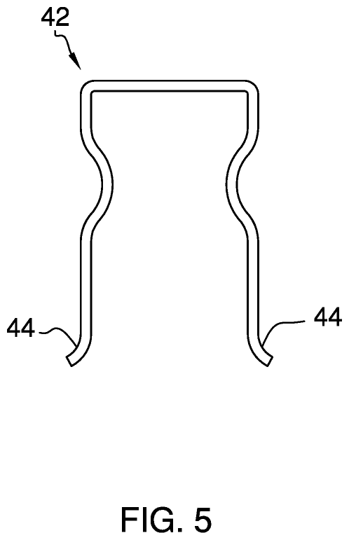

With reference now to the drawings, and in particular to FIGS. 1 through 5 thereof, a new stabilization device embodying the principles and concepts of an embodiment of the disclosure and generally designated by the reference numeral 10 will be described.

As best illustrated in FIGS. 1 through 5, the ladder stabilization assembly 10 generally comprises a pair of eyebolts 12 that can be attached to a respective leg 14 of a ladder 16. The ladder 16 may be a step ladder, an extension ladder or any other type of ladder. Each the eyebolts 12 comprises a screw 18 and an eye 20. The eye 20 has a plurality of intersecting members 22 such that the eye 20 has a rectangular shape. Additionally, the screw 18 engages the respective leg 14 for attaching the eyebolts 12 to the ladder 16. Each of the eyebolts 12 is positioned adjacent to a bottom end 24 of the respective leg 14. The screw 18 of each of the eyebolts 12 is coupled to and is oriented at an acute angle with a respective one of the intersecting members 22 of the eye 20. In this way the eye 20 of the eyebolts 12 can lie flat on the ground when the ladder 16 is stood into position.

A plurality of washers 24 is provided and each of the washers 24 is positionable around the screw 18 of a respective one of the eyebolts 12 when the stem of the respective eyebolt 12 is extended through the respective leg 14 of the ladder 16. A plurality of nuts 26 is provided and each of the nuts 26 is threadable onto the screw 18 of a respective one of the eyebolts 12 when the screw 18 of the respective eyebolt 12 is extended through the respective leg 14 of the ladder 16. In this way each of the nuts 26 can retain the respective eyebolt 12 on the respective leg 14.

A tube 28 is provided and the tube 28 is insertable through each of the eyebolts 12 such that the tube 28 is oriented to extend along a horizontal axis. In this way the tube 28 rests against a support surface 30 on which the ladder 16 is positioned to inhibit the ladder 16 from tipping laterally. The tube 28 has a first end 32, a second end 34 and an outer surface 36 extending therebetween, and the outer surface 36 has a plurality of intersecting sides 38 such that the tube 28 has a rectangular shape. Each of the intersecting members 22 of the eye on each of the eyebolts 12 abuts a respective one of the intersecting sides 38 of the outer surface 36 when the tube 28 is extended through the eyebolts 12. Additionally, each of the first end 32 and the second end 34 is open. A pair of caps 40 is provided and each of the caps 40 is removably attachable to a respective one of the first end 32 and the second end 34 of the tube 28. Each of the caps 40 may have a rectangular shape to conform to the profile of the tube 28.

A pair of clips 42 is provided and each of the clips 42 is attached to a respective leg 14 of the ladder 16. The clips 42 are spaced apart from each other on the respective leg 14 and each of the clips 42 includes a pair of arms 44 that are spaced apart from each other such that the tube 28 can be positioned between the arms 44 to store the tube 28 in the clips 42. Additionally, the arms 44 on each of the clips 42 are biased toward each other for releasably retaining the tube 28 in the clips 42. Each of the clips 42 may be attached to the respective leg 14 with fasteners such as nuts and bolts or the like.

In use, each of the eyebolts 12 is fastened to the respective leg 14 of the ladder 16 and the tube 28 is extended through each of the eyebolts 12. In this way the tube 28 is horizontally oriented and extends along the support surface 30. Thus, the ladder 16 is inhibited from tipping over laterally when the ladder 16 is being climbed. In this way the tube 28 enhances safety for a user when the user is climbing the ladder 16. The tube 28 is removable from the eyebolts 12 when the ladder 16 is not being used.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A ladder stabilization assembly for inhibiting a ladder from tipping sideways, said assembly comprising:
a pair of eyebolts each being configured to be attached to a respective leg of a ladder; and
a tube being insertable through each of said eyebolts such that said tube is oriented to extend along a horizontal axis wherein said tube is configured to inhibit the ladder from tipping laterally.

2. The assembly according to claim 1, wherein each said eyebolts comprises a screw and an eye, said eye having a plurality of intersecting members such that said eye has a rectangular shape, said screw engaging the respective leg for attaching said eyebolts to the ladder.

3. The assembly according to claim 2, further comprising a plurality of washers, each of said washers being positionable around said screw of a respective one of said eyebolts when said stem of said respective eyebolt is extended through the respective leg of the ladder.

4. The assembly according to claim 2, further comprising a plurality of nuts, each of said nuts being threadable onto said screw of a respective one of said eyebolts when said screw of said respective eyebolt is extended through the respective leg of the ladder wherein each of said nuts is configured to retain said respective eyebolt on the respective leg.

5. The assembly according to claim 2, wherein said tube has a first end, a second end and an outer surface extending therebetween, said outer surface having a plurality of intersecting sides such that said tube has a rectangular shape, each of said intersecting members of said eye on each of said eyebolts abutting a respective one of said intersecting sides of said outer surface when said tube is extended through said eyebolts, each of said first end and said second end being open.

6. The assembly according to claim 5, further comprising a pair of caps, each of said caps being removably attachable to a respective one of said first end and said second end of said tube.

7. A ladder stabilization assembly for inhibiting a ladder from tipping sideways, said assembly comprising:
a pair of eyebolts each being configured to be attached to a respective leg of a ladder, each said eyebolts comprising a screw and an eye, said eye having a plurality of intersecting members such that said eye has a rectangular shape, said screw engaging the respective leg for attaching said eyebolts to the ladder;
a plurality of washers, each of said washers being positionable around said screw of a respective one of said eyebolts when said stem of said respective eyebolt is extended through the respective leg of the ladder;
a plurality of nuts, each of said nuts being threadable onto said screw of a respective one of said eyebolts when said screw of said respective eyebolt is extended through the respective leg of the ladder wherein each of said nuts is configured to retain said respective eyebolt on the respective leg;
a tube being insertable through each of said eyebolts such that said tube is oriented to extend along a horizontal axis wherein said tube is configured to inhibit the ladder from tipping laterally, said tube having a first end, a second end and an outer surface extending therebetween, said outer surface having a plurality of intersecting sides such that said tube has a rectangular shape, each of said intersecting members of said eye on each of said eyebolts abutting a respective one of said intersecting sides of said outer surface when said tube is extended through said eyebolts, each of said first end and said second end being open; and
a pair of caps, each of said caps being removably attachable to a respective one of said first end and said second end of said tube.

8. A ladder stabilization system for inhibiting a ladder from tipping sideways, said system comprising:
a ladder having a pair of legs;
a pair of eyebolts each being attached to a respective leg of said ladder, each said eyebolts comprising a screw and an eye, said eye having a plurality of intersecting members such that said eye has a rectangular shape, said screw engaging said respective leg for attaching said eyebolts to said ladder;
a plurality of washers, each of said washers being positionable around said screw of a respective one of said eyebolts when said stem of said respective eyebolt is extended through said respective leg of said ladder;
a plurality of nuts, each of said nuts being threadable onto said screw of a respective one of said eyebolts when said screw of said respective eyebolt is extended through said respective leg of said ladder to retain said respective eyebolt on said respective leg;
a tube being insertable through each of said eyebolts such that said tube is oriented to extend along a horizontal axis to inhibit said ladder from tipping laterally, said tube having a first end, a second end and an outer surface extending therebetween, said outer surface having a plurality of intersecting sides such that said tube has a rectangular shape, each of said intersecting members of said eye on each of said eyebolts abutting a respective one of said intersecting sides of said outer surface when said tube is extended through said eyebolts, each of said first end and said second end being open; and
a pair of caps, each of said caps being removably attachable to a respective one of said first end and said second end of said tube.
